(19) United States
(12) Patent Application Publication
(10) Pub. No.: US 2005/0029931 A1
(43) Pub. Date: Feb. 10, 2005

(54) Photostabilised organic material

(76) Inventors: Terence A. King, Manchester (GB); Mark d. Rahn, Stockport (GB); Mohammad Ahmad, Manchester (GB)

Correspondence Address: NIXON & VANDERHYE, PC, 1100 N GLEBE ROAD, 8TH FLOOR, ARLINGTON, VA, 22201-4714, US

(21) Appl. No.: 10/493,618

(22) PCT Filed: Oct. 25, 2002
(86) PCT No.: PCT/GB02/04868

(30) Foreign Application Priority Data
Oct. 25, 2001 (GB) 01256117.1

(51) Int. Cl. H05B 33/10

(52) U.S. Cl. 313/504; 313/503

(57) ABSTRACT

The photostability of organic material is enhanced by the incorporation of a plurality of particles which may for example have a diameter of 0.03 microns to 2.5 microns. The organic material may be a light absorbing material and may be photoluminescent or electroluminescent. Compositions in accordance with the invention incorporating an electroluminescent material of enhanced photostability may be used in an Organic Light Emitting Diode (OLED).

The present invention relates to photostabilised organic material, and particularly though not exclusively to photostabilised photoluminescent organic material or photostabilised electroluminescent organic material.

Photoluminescent organic materials (as dopants, photosensitisers or chromophores or polymers) are becoming an increasingly important class of materials. Their role as efficient light emitters has led to the success of dye lasers over the last three decades. Considerable research has confirmed the successful incorporation of photoluminescent organic materials as active laser molecules into solid host materials [1]. Photoluminescent organic materials also have important application in optoelectronics in nonlinear devices [3] and photovoltaic devices [4].

Electroluminescent materials have been produced by developing electrically conducting photoluminescent materials [2]. These include dye-doped conductors, hosts and conjugated polymers. This in turn has led to the important commercial development of polymer LED's and full color displays.

Photodegradation is a fundamental problem which affects organic materials, and particularly photoluminescent organic materials and electroluminescent organic materials. High optical power densities are typically generated in organic LED's and organic lasers. Photodegradation occurs as a result of the high fluence and/or optical power densities, and steadily destroys the organic material. An attempt to address this disadvantage has been made by using packing techniques to reduce the amount of oxygen molecules in optoelectronic devices (it is generally believed that photodegradation of many organic materials is caused by photo-oxidation). It has been found that this technique provides a limited increase of the operational lifetimes of the devices.

Few techniques are available to enhance the photostability of solid or liquid photoluminescent materials. The most notable are the removal of oxygen from the material, the avoidance of ultra-violet exposure and the use of anti-oxidants (which include molecules preferentially reacting with oxygen, singlet oxygen quenchers and free radical scavengers) [5-10]. These techniques provide a limited increase of the operational lifetimes of photoluminescent material.

It is an object of the present invention to provide an organic material which is photostabilised by a mechanism which enhances those described above or provides an additional mechanism.

According to the first aspect of the present invention there is provided a composition comprising an organic material and a plurality of particles which serve to enhance photostability of the material.

The particles preferably do not include internally any photo-active elements, including photoluminescent, electroluminescent, pigmented or absorbing media. It is not intended to preclude the adsorption by the particles of oxygen molecules or chromophores or photosensitive or dye molecules which may affect or modify the optical properties.

If the organic material has optical clarity then the size and concentration of the particles may preferably be such that the optical clarity of the organic material is maintained or substantially maintained. The reference to maintaining the optical clarity is intended to mean that addition of the inert particles to the organic material does not significantly affect optical transmission, scattering or wave guiding properties of the organic material.

The term ‘sorganic material’ is intended to include organic molecules and organic polymers. The material can be either in the solid or liquid phase.

Preferably the organic material is a light absorbing material, i.e. with absorption in the electromagnetic spectrum, e.g. visible spectrum.

According to a second aspect of the present invention there is provided a composition comprised of a light absorbing organic material and a plurality of particles which serve to enhance photostability of the material.

Preferably the particles (for compositions in accordance with either the first of second aspect of the invention) are transparent.

Suitably, the material is a luminescent material.

Suitably, the material is a photoluminescent material.

Suitably, the material is an electroluminescent material.

Suitably, the particles have a diameter less than 5 microns.

Suitably, the particles have a diameter greater than 0.001 microns (1 nm) e.g. greater than 0.005 microns (5 nm), or greater than 0.01 microns (10 nm).

Suitably, the particles have a diameter between 0.03 microns and 2.5 microns.

Suitably, the particles have a diameter which is not less than 100 (preferably not less than 1000) times smaller than the wavelength of light in which the organic material is desired to be photostable.

The term ‘light’ is intended to include electromagnetic radiation which falls within or outside of the visible spectrun.

Suitably, the particles have a diameter which is not less than 20 times smaller than the wavelength of light in which the organic material is desired to be photostable.

Suitably, the particles have a diameter which is not more than 30 times greater than the wavelength of light in which the organic material is desired to be photostable.

Suitably, the particles have a diameter which is not more than 6 times greater than the wavelength of light in which the organic material is desired to be photostable.

Suitably, the concentration of particles in the organic medium is between approximately 0.01 and 10 mg/ml.

Suitably, the concentration of particles in the organic medium is between approximately 0.05 and 1 mg/ml.

Suitably, the total particle surface area is between 2.8×10⁻⁶ and 6.5×10⁻² cm² per ml.

Suitably, the total particle surface area is between 2.4×10⁻⁴ to 1.3×10⁻² cm² per ml.

Suitably, the particles are made from ceramic, glass, polymer, latex polymer, silica, colloidal silica, sols, borosilicate glass, β-alumina, PMMA or polystyrene.

Compositions in accordance with the invention may take various forms and have numerous uses. Depending on the organic material, the composition may be a photovoltaic, dyestuff, printing ink, paint, plastics sheet, plastics filter, solar converter, laser, organic light emitting diode (OLED), non-linear optical devices, saturable absorbers, q-switches, optical limiters, fluorescent optical fibre, optical modelockers, optical upconverters, scintillator material or a pharmaceutical (e.g. a drug for photodynamic therapy). All of such products may benefit from photostabilisation in accordance with the invention.

One preferred embodiment of composition in accordance with the invention is a lasing medium since photostability of such a medium is an important factor. The laser medium may be made up of an organic dye molecule in liquid or solid host phase. Molecules may be such as rhodamine 6G, pyrromethenes, perylenes, coumarins and stilbenes. The liquid solvent may be alcohols, water, hydrocarbons, chlorinated solvents or ketones. The solid host may be a polymer, gels, organic glasses or sol-gel glasses.

A further embodiment of the invention is a composition comprising a photoluminescent material, e.g. pyrromethene 567, rhodamine 6G or coumarin 590. These materials are typically used for example in lasers, nonlinear devices, scintillators, OLEDs, fluorescent materials for decoration, displays and signs.

A particularly preferred embodiment of the invention is a composition comprising an electroluminescent material. Such compositions may be used for OLEDs where photostability of the organic material is an important factor. In the case of an OLED the particle size is preferably 1 to 20 nanometers.

An OLED (Organic Light Emitting Diode) is typically a thin film of electroluminescent organic material sandwiched between two electrodes. A voltage is applied across the electrodes and the resulting current produces the emission of photons via the electroluminescence effect. Holes are injected at the anode and electrons are injected at the cathode, they annihilate in the bulk of the organic film resulting in an exciton, a bound electron-hole pair. The exciton decays to the ground state of the organic material and a photon is emitted.

The structure is normally, but not exclusively, on a glass substrate with an indium tin oxide film to act as the anode. The organic film is normally spin-coated on the substrate to a typical thickness of 100 nm, which may vary in some cases up to several microns. Often multiple organic layers are used, and a common configuration is two layers engineered to balance electron and hole transport and injection. The cathode is vapour deposited on top of the organic layers and is preferably made of a low work function metal such as calcium, but aluminium is often used.

An OLED always has a current flow. All OLEDs are electroluminescent (sometimes also called electrophosphorescent).It is possible, but rare, to have a weakly photoluminescent material that is strongly electrolumninescent. If the efficiency is inceased to such an extent that optical gain is produced the emission becomes laser like (the so-called electrically pumped organic laser). The emission spectrum of OLEDs is usually quite broad.

Applications include discrete diodes, and arrays of diodes to produce an image display. But large areas can also be fabricated for lighting, packaging or advertising applications.

Organic materials used for OLEDs include:
(i) Molecules such as Alq3 (8-hydroxyquinolene aluminium) or paraphenylenevinylene for example. These are often blended with a charge transporting matrix to increase electrical conduction. Many such molecules exist, but their common feature is an electronic excited state that when decays, emits a photon in the visible.
(ii) Polymers such as PPV (poly(phenylene vinylene)) and polyfluorenes. They also have an electronic excited state which decays emitting a photon in the visible, but the exciton is less well defined and may extend over several repeat units of the polymer chain. Charge transport also occurs in the polymer.
(iii) Dendrimers. The tentacles of the dendrimer “harvest” charge passing by and funnels it to a central unit which is able to support an exciton which can decay emitting a photon.
(iv) Organometallics. These are complexes of organic groups and metal ions, e.g. lanthanide atoms. These can be both photoluminesent and electroluminescent and the excitation is transported via an organic group to the lanthanide. The lanthanide decays emitting a photon, but in a very narrow spectral bandwidth. The pure color is beneficial to color displays. Also the lifetime of the exciton is much longer, which may make laser action easier to achieve. Organolanthanides are a subclass of transition metal phosphorescents.
(v) There are many combinations and blends of the above.

Specific embodiments of the invention will now be described by way of example only, with reference to the accompanying figures in which:

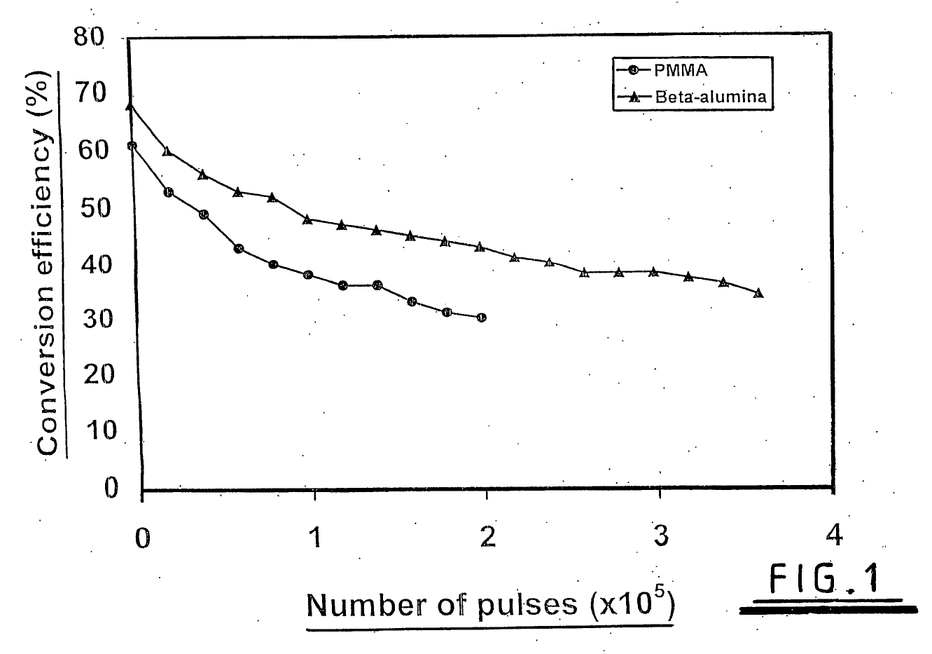

FIG. 1 is a graph which shows the performance of a laser dye material which embodies the invention;

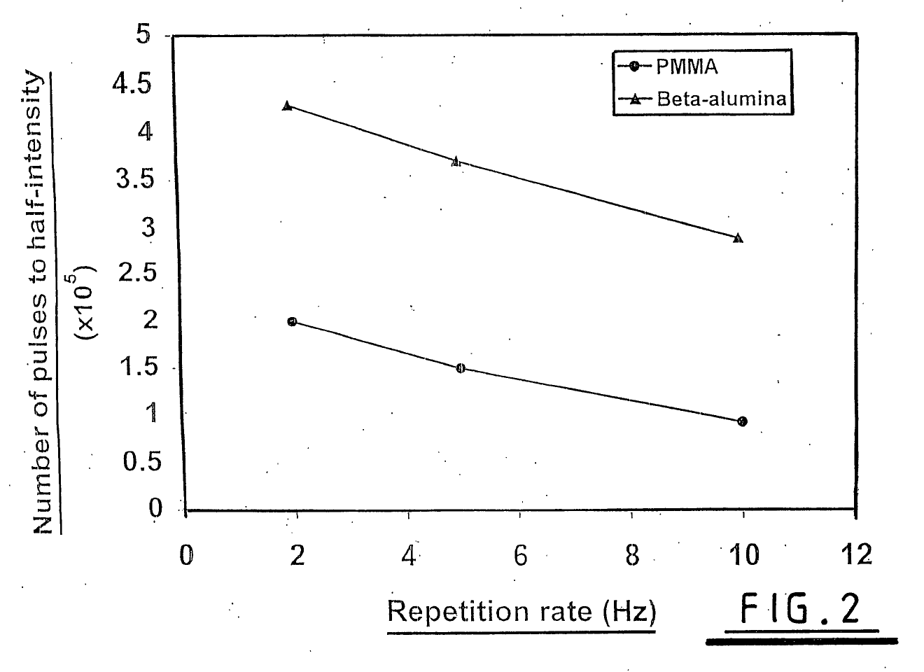

FIG. 2 is a graph which shows the half-life of laser operation of two materials which embody the invention;

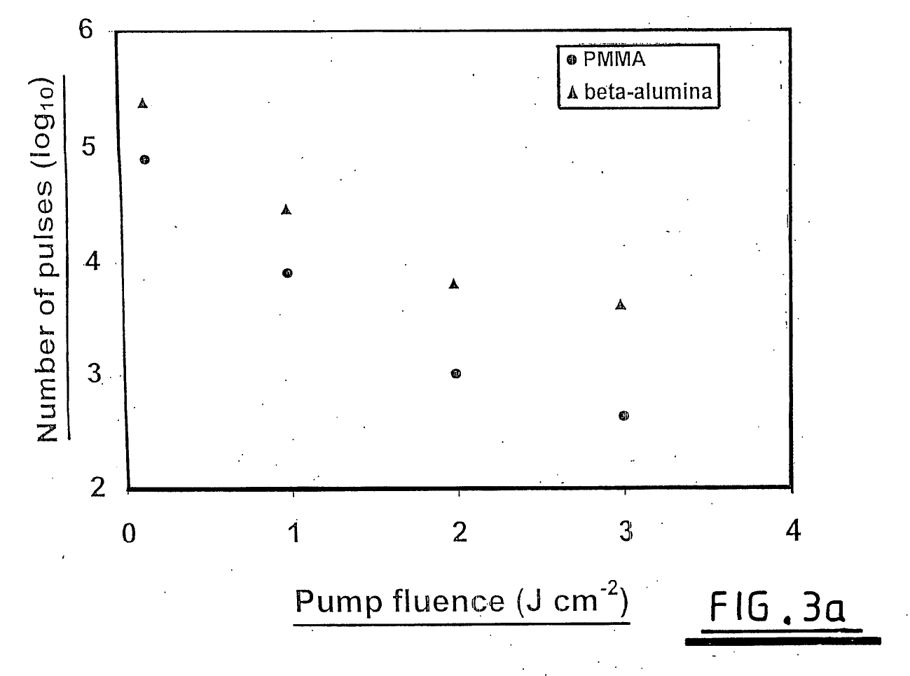

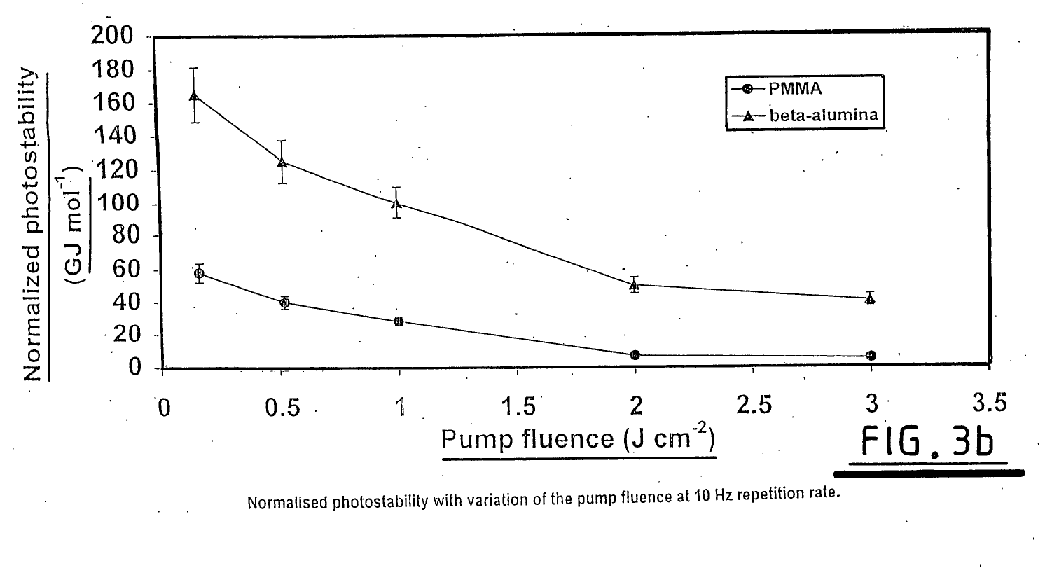

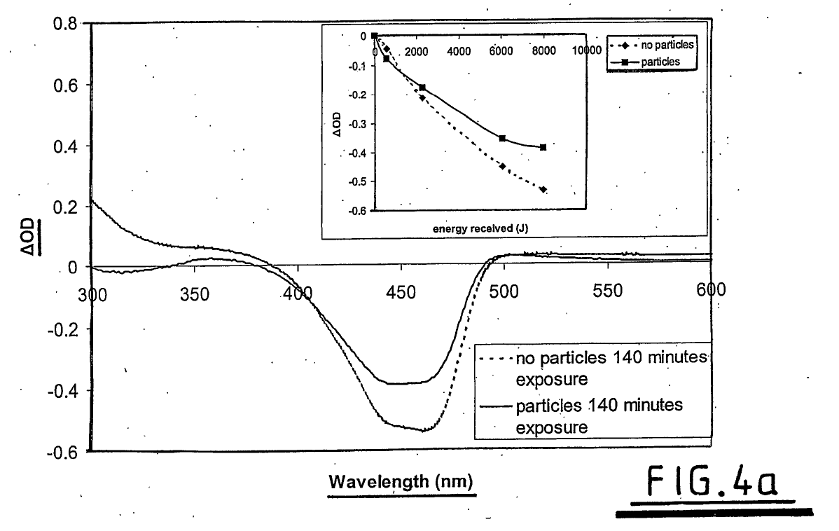

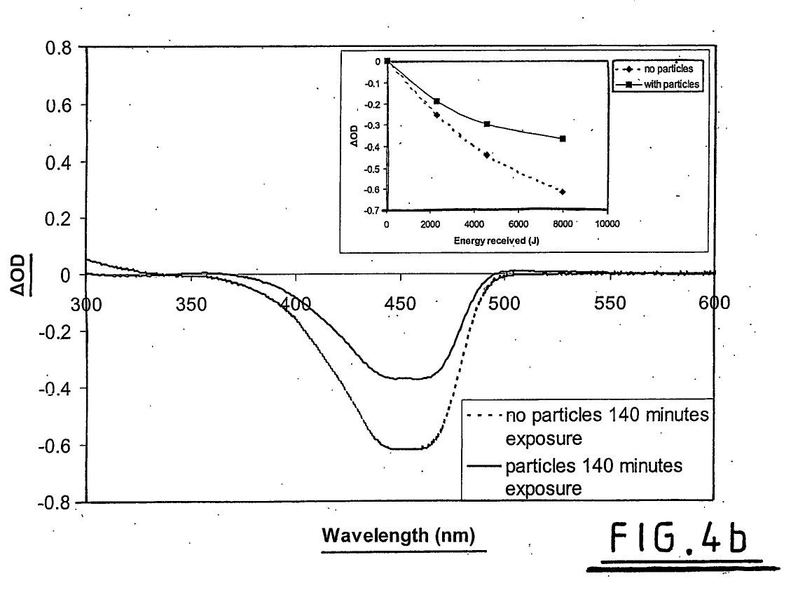

FIG. 3 is a graph which indicates the operation lifetime of a material which embodies the invention; and FIG. 4 is a graph indicating photostabilisation of a solution that embodies the invention.

The described embodiments of the invention relate to photoluniinescent organic materials.

In a first set of experiments, two photostabilised organic laser dye materials which embody the invention have been made. The use of laser dyes in laser cavities is advantageous because it allows accurate testing of the photostability of the organic materials, due to the delicate balance of optical gain versus loss which occurs in lasers.

The two laser dye materials that were selected as examples of the invention are rhodamine 6G solution and pyrromethene 567 solution (also known as 1, 3, 5, 7, 8-pentamethy-2-6-diehylpyrromethene-BF₂). Each solution was either of pure ethanol or ethanol with a low fraction of water. Standard solutions of dye and solvent were prepared with typical concentration of 10⁻⁴ Molar dye. Inert microparticles were added to the solutions (the form of the microparticles is described further below). All dyes were laser grade and all solvents of spectroscopic grade. All samples were sonicated in a bath in order to ensure that the microparticles and dye were properly in solution.

In addition to being held in liquid solutions, each dye was separately doped into polymer methyl methacrylate (PMMA), a solid polymer and also into a sol-gel glass. The polymer was made from methyl methacrylate monomer that was distilled to remove the polymerisation inhibitor, hydroquinone monomethyl ether. The pyrromethene 567 was dissolved into the monomer at 3.4×10⁻⁴ M concentration and the mixture was placed in a water-filled ultrasonic bath until the dye was completely dissolved. The R6G was dissolved into the monomer at 3.4×10⁻⁴ M concentration and the mixture was placed in a water-filled ultrasonic bath until the dye was completely dissolved. In the case of R6G 10% ethanol was added to aid solubility. Microparticles were added to each dye solution along with 1 mg/ml 2,2-azobis 2-methylpropiontrile polymerisation initiator (the form of the microparticles is described further below). Finally, each mixture was replaced in the ultrasonic bath for a few minutes. The resulting monomer solutions, in sealed test tubes, were placed in a water bath at a temperature of 40° C. for 2 to 3 days until a viscous liquid was formed. The tubes were then transferred to an oven where the temperature was increased step-wise at 5° C./day until it reached 90° C. Then the temperature was reduced over two days to room temperature. The glass tubes were broken to remove the polymerised samples which were then cut into disks and polished to optical quality.

The microparticles added to the dyes included:

(a) latex polymers of 0.028 μm and 0.098 μm diameter;

(b) silica particles of 0.5 μm;

(c) borosilicate glass of 2.5 μm; and

(d) β-alumina particles of diameter <2 μm.

In each case different concentrations of microparticles were used, the concentrations were estimated to be in the range 0.01 to 9.75 mg/ml.

Photostability was tested by irradiating each sample inside a laser cavity, with the dye sample suitably positioned within the cavity to allow it to act as a laser medium (i.e. the cavity forms a dye laser). As previously mentioned, a delicate balance of optical gain versus loss occurs in laser cavities. Consequently, the output generated by the dye laser acts as a sensitive test of the degradation of the dye medium.

The laser cavity was a compact plane-plane configuration, as used in reference [6]. The input mirror was dichroic with 90% transmission of 532 nm and 95% reflectivity between 560 nm and 600 nm. The output mirror was a 70% broadband reflector that was not necessarily optimum for highest efficiency. A short cavity length of 15 mm was used to reduce the cavity losses due to a highly divergent output. The pump source was a Q-switched Nd:YAG laser operating at the second harmonic 532 nm. This delivered up to 60 mJ/pulse in 6 ns at 1 Hz to 10 Hz repetition rate, or in a single pulse. A 20 mm focal length lens focused the pump beam onto the sample. The sample was placed before the focus such that the diameter of the pump beam was 2 mm at the sample input face. The pump beam was aligned off-axis at a slight tilt angle of 16° to the resonator axis so that any transmitted pump light was not collinear with the output beam and did not fall onto the volume absorbing power meter.

Photostability experiments on the solid pyrromethene 567 and rhodamine 6G samples were performed by varying the pump fluence from 0.16 to 3.0 J cm⁻² and the repetition rate from 2 to 10 Hz. Through these experiments, different aspects of the dependence of laser performance on excitation of the solid samples have been studied. The conversion efficiency of the laser was measured as a function of input energy and the number of input pulses. After testing, the samples were inspected for signs of laser damage to the bulk.

The laser performance of the liquid pyrromethene 567 and rhodamine 6G samples was evaluated using 1 ml of dye solution (1×10⁻⁴ M pyrromethene or 5×10⁻⁵ M rhodamine 6G) in a 1 cm optical path length cuvette. The pump laser pulse energy was 15.4 mJ at a 10 Hz repetition rate.

The photostability experiments carried out using the solid materials revealed substantially increased photostability. Data obtained from 3.4×10⁻⁴ M pyrromethene 567 doped PMMA with and without microparticles is presented in FIG. 1 for a 2 Hz repetition rate and a pump fluence of 0.16 J cm⁻². The samples used were 8 mm long. The conversion efficiency is defined here as the ratio of the output pulse energy to the pump pulse energy incident onto the sample. The number of pulses taken for the conversion efficiency to fall to one-half of its initial value is seen to increase from 0.2 million pulses to 0.4 million pulses for samples containing microparticles. Microparticles had no effect on the laser efficiency of either solutions or dye-doped PMMA.

An increase in the repetition rate reduced the laser operation lifetime of the solid materials. The same samples as those used for the 2 Hz repetition rate study were also tested at 5 Hz and 10 Hz. If the assumption is made that photochemical processes are complete in the 100 ms between pulses, then this measurement tests some aspects of the thermal properties of the material. If a 2 Hz repetition rate is used then 10 mW of power is deposited in the active region. At 10 Hz, the figure is 50 mW. FIG. 2 shows the half-life of laser operation for the two materials at three different repetition rates (i.e. the number of pulses emitted by the solid state dye laser before the emission peak intensity fell by 50%). The pump fluence was 0.16 Jcm⁻² in all cases, and all the samples were 8mm long and doped with a pyrromethene 567 dye concentration of 3.4×10⁻⁴ M. It can be seen from FIG. 2 that the reduction factor in lifetime with repetition rate is comparable as the pulse repetition rate is increased, indicating that the thermal processes are similar for the PMMA containing microparticles and the PMMA without microparticles.

The dependence of the laser performance of the laser dyes in liquid solution with and without microparticles was investigated. The photostability was normalised in units of the total average pump energy absorbed by the sample per mole of the dye at which the laser intensity is reduced to one-half For pyrromethene 567 in ethanol, the normalised photostability increased by a factor of three up to 18 GJ mol⁻¹ for samples containing β-alumina micro-particles (normalised photostability is defined in reference [1]). There was no noticeable effect on the laser efficiency with microparticles doping. The dye laser output wavelength was 565 nm. The normalised photostability of rhodamine 6G in ethanol for samples containing microparticles increased from 20 GJ mol⁻¹ to 60 GJ mol⁻¹ and the output wavelength was 575 nm.

To provide a genuine test of the pyrromethene 567 doped PMMA's capacity as a gain medium for a solid-state dye laser the operational lifetime was measured at high power; this was carried out at a 10 Hz repetition rate using pump fluences ranging from 0.16 to 3 J cm⁻². FIG. 3 shows the number of pulses (3a) and nornalised photostability (3b) as a function of the pump fluence at 10 Hz repetition rate. The data were all taken with 8 mm long samples of PMMA doped with a pyrromethene 567 dye concentration of 3.4×10⁻⁴ M. FIG. 3 shows that increasing the pump fluence reduces the operation lifetime as would be expected. It is to be noticed that the addition of microparticles increases the photostability by a factor of over five times.

The second dye studied, R6G, is generally an order of magnitude less stable that P567 in a solid-state dye laser [6]. However, the addition of microparticles to a solid PMMA sample containing rhodamine 6G, provided the same proportion of enhancement to the photostability as for P567.

No laser damage occurred in micro-particle doped solid-state PMMA at all of the pump fluences used in this study. PMMA samples alone showed both surface and bulk damage when pumped with a fluence higher than 1.0 J cm⁻². This addition of micro-particles also provides a higher laser damage threshold.

A second set of experiments were carried using out using pyrromethene 567 and a variety of microparticle types and sizes. The photostability of dye solutions containing each type of microparticle was tested at different microparticle concentrations and the results were compared to a control sample of 10⁻⁴M pyrromethene 567 that contained no microparticles. The size range of the added microparticles varied from well below the wavelength of light to well above it (0.028 μm-2.51 μm compared with a pump wavelength of 0.532 μm). Table 1 shows the different types of microparticles used.

TABLE 1
Types and sizes of microparticles used.

| Particle Type | Particle Size (μm) |
|---|---|
| Latex | 0.028 |
| Latex | 0.098 |
| Silica | 0.5 |
| Borosilicate Glass | 2.5 |

All photostability experiments were carried out with pure ethanol as a solvent or with ethanol with a low water content in a fixed ratio. For each data set, standard solutions of dye and solvent were prepared and the required additives and microparticles added. Standard dye solutions were prepared with concentration of 10⁻⁴ molar and these standard solutions were diluted where necessary. All dyes used were laser grade and all solvent spectroscopic grade. In order to ensure all dye microparticles were properly in solution all samples were placed in an ultrasound bath during all stages of preparation.

Samples of dye solution with and without doping of 0.028 μm latex particles were prepared as previously and the desired volumes added to 10 mm path length cuvettes. Each cuvette was then sealed with microfilm and bubbled with nitrogen through a tapered syringe for a fixed period. A second syringe was used to remove excess gas from the system. After bubbling, the syringes were removed and the cuvettes immediately resealed with additional microfilm. All experiments were carried out with 10⁻⁴ M pyrromethene 567 solutions.

The experiments were carried out using 0.3-0.6 ml of dye solution in a 10 mm path length cuvette placed in a compact plane-plane laser cavity. The pump source was a frequency doubled, Q-switched Nd:YAG laser emitting 10 ns pulses at 532 nm and operating with a repetition rate of 10 Hz.

A focusing lens was used to focus the beam into the cavity. The input mirror was dichroic with 90% transmission at 532 nm and 95% reflectivity between 560 and 600 nm. The output mirror being a broad reflector of 70%. The pump beam was aligned at a small angle between 14° and 16° to the resonator axis in order to ensure transmitted pump radiation was not collinear with the output beam and could not be detected by the power meter. During experiments a photosensitive power meter was used to measure output voltages which were recorded in each case as a function of time with the appropriate computer software.

Aside from those involving nitrogen bubbling, all experiments were performed in aerated conditions and at identical temperatures with the performance of the pump laser measured at regular intervals for consistency.

The experiments were carried out using the laser cavity described above, and quantitative photostability comparisons were carried out using the normalised photostability defined by Rahn and King[1]. Here, the conversion efficiency was determined as a function of the input energy or number pulses. A normalised figure for photostability of each dye solution in energy per mole can therefore be calculated by considering the energy required to degrade the conversion efficiency to half of its initial value. This provides a direct measure of average number of photons that a given molecule may absorb before photodegradation occurs. It may also be measured during laser operation and accounts for all decay processes.

TABLE 2
Table of results for pyrromethene 567 solution.

| | Particle | Initial | Normalised | |
|---|---|---|---|---|
| P567 | Conc | Conversion | Photostability | |
| Conc | (mg/ml) | Efficiency % | (GJ mol⁻¹) | No. Pulses |
| (mol) | (±10%) | (±2%) | (±2 GJ mol⁻¹) | (±4000) |

2.5 μm
Borosilicate Glass

| | | | | |
|---|---|---|---|---|
| 10⁻⁴ | 0 | 94 ± 2 | 9 | 18000 |
| 10⁻⁴ | 0.05 | 88 ± 2 | 21 | 42000 |
| 10⁻⁴ | 0.01 | 89 ± 2 | 20 | 40000 |

0.5 μm Silica

| | | | | |
|---|---|---|---|---|
| 10⁻⁴ | 0 | 97 | 9.5 | 19000 |
| 10⁻⁴ | 0.03 | 85 | 15 | 32000 |
| 10⁻⁴ | 0.1 | 98 | 20 | 40000 |
| 10⁻⁴ | 0.25 | 95 | 16 | 32000 |

0.5 μm Silica

| | | | | |
|---|---|---|---|---|
| 10⁻⁵ | 0 | 68 | 9.5 | 19000 |
| 10⁻⁵ | 0.05 | 68 | 16 | 32000 |
| 10⁻⁵ | 0.1 | 72 | 16 | 32000 |
| 10⁻⁵ | 0.2 | 63 | 16 | 32000 |
| 10⁻⁵ | 0.5 | 61 | 22 | 44000 |
| 10⁻⁵ | 0.75 | 65 | 10 | 20000 |

0.098 μm Latex

| | | | | |
|---|---|---|---|---|
| 10⁻⁴ | 0 | 71 | 3 | 6000 |
| 10⁻⁴ | 0.01 | 72 | 5 | 10000 |
| 10⁻⁴ | 0.025 | 70 | 5 | 10000 |
| 10⁻⁴ | 0.05 | 71 | 4.75 | 9500 |
| 10⁻⁴ | 0.1 | 45 | 2.5 | 5000 |
| 10⁻⁴ | 0.25 | 30 | 0.75 | 1500 |

0.028 μm Latex

| | | | | |
|---|---|---|---|---|
| 10⁻⁴ | 0 | 70 | 3 | 6000 |
| 10⁻⁴ | 0.025 | 70* | 5 | 10000 |
| 10⁻⁴ | 0.05 | 71 | 6 | 12000 |
| 10⁻⁴ | 0.075 | 70* | 6 | 12000 |
| 10⁻⁴ | 0.1 | 71 | 6.5 | 13000 |
| 10⁻⁴ | 0.15 | 70* | 5.5 | 11000 |
| 10⁻⁴ | 0.25 | 65 | 3.25 | 6500 |
| 10⁻⁴ | 0.5 | 69 | 2.5 | 5000 |
| 10⁻⁴ | 1 | 30 | 0.75 | 1500 |

Solvent: ethanol and water in 3:1 ratio.

As described above the nomalised energy input is defined as the cumulative pump energy on the laser cavity per mole of dye molecules contributing to laser action. A summary of the results taken is shown in Table 2.

It is apparent from table 2 that the presence of microparticles with diameters above, below and comparable to the laser wavelengths used has an effect on the photostability of the cavity which is dependant on their concentration. It can also be seen that the maximum observed magnitudes of the effect is similar in each case with an increase in the normalised photostability in the region of 100%. It is clear from the results shown in table 2 that the magnitude of photostability effects depends strongly on the concentration with a range of optimum values for the microparticle concentration.

For each data set a maximum photostability was observed which was significantly greater than that for the plain dye solution with smaller increases noted for concentrations above and below this value. At higher concentrations the microparticles had no effect or reduced the normalised photostability. Each of these effects have been observed without significant changes to other laser characteristics.

It is clear that for each of the dye solutions prepared there will be a microparticle concentration above which the laser performance will be impaired from the increased scattering as the solution becomes saturated and more opaque. This was seen as a marked reduction in the initial conversion efficiency as the concentration is increased. This effect was observed for all microparticles investigated often resulting in visibly different solutions for which laser operation was impossible. However, reductions in the photostability of dye samples were observed at higher concentrations without a significant reduction in the initial conversion efficiency, suggesting that increased scattering was not necessarily the sole cause of the reduced laser lifetime.

The precise relationship between the concentration of the microparticles used and the photostability of the cavity remains unclear. It seems reasonable to conclude from the data displayed that there is an optimum microparticle concentration or range of concentrations to achieve a maximum laser longevity for all of the microparticles tested, the value of which is specific to the size and possibly material of microparticles used.

Preliminary data was taken using two other dyes: Rhodamine 6G and coumarin 590. In each case a concentration of 10⁻⁴ M was used. All these experiments were carried out with a filtered β-alumina particles, prepared by grinding with a pestle and mortar, in an ethanol solution.

TABLE 3
Approximate photostability enhancement factors

| | Photostability | |
|---|---|---|
| Dye | Enhancement | Approximate |
| Pyrromethene 567 | Yes | 2 |
| Rhodamine 6G | Yes | 1.5 |
| Coumarin 590 | Yes | 1.5 |

The results confirm that a similar effect is observed in other dyes.

The presence of microparticles in nitrogen bubbled dye solutions produced photostability increases which correspond to those previously observed, as shown in table 4. Part of the photostability increase may be arise from incomplete removal of oxygen from the samples.

TABLE 4
Results involving deoxygenated samples.

| | | | Initial | Normalised | |
|---|---|---|---|---|---|
| Particle | Bubbling | Sample | Conver- | Photostability | Number |
| Conc. | Time | Volume | sion | (±2 GJ/mol) | of pulses |
| (0.025 μm) | (Minutes) | (ml) | (±2%) | (GJ/mol) | (±4000) |
| 0 | 0 | 3 | 67 | 3 | 60000 |
| 0 | 30 | 3 | 69 | 5.5 | 110000 |
| 0.75 | 30 | 3 | 70 | 11 | 220000 |
| 0 | 0 | 0.5 | 66 | 3.25 | 10800 |
| 0 | 120 | 0.5 | 68 | 8 | 26600 |
| 0.75 | 120 | 0.5 | 69 | 15 | 60000 |

All solutions are 10⁻⁴ Molar pyrromethene 567 in 3:1 ethanol:water solution.

The microparticles used were 0.028 μm latex spheres. Due to the longevity of these samples, the values for normalised photostabilities displayed were not calculated from decays of 50% but from extrapolations of 15% decays. As a result the experimental errors on such valves were higher than expected. The results show, for latex microparticles, that increased photostability was observed upon the addition of microspheres, in addition to increased photostability arising from partial oxygen removal.

Further numerical analysis was undertaken to test any relationship between the observed effect and any other physical parameters. Thus the number, total surface area and total volume of particles was calculated for each particle type at the concentration that gave the optimum increase in photostability. Table 5 shows the results of this analysis.

TABLE 5
Further calculation of related parameters.

| Par- | Particle | Estimated | | | |
|---|---|---|---|---|---|
| ticle | Concen- | number | Estimated | Estimated | Dye |
| diam- | tration | (10⁻⁴ M) dye | number | surface | Molecules |
| eter | (mg/ml ± | molecules | particles | area | per |
| (μm) | 10%) | (10¹⁶ ml⁻¹) | (m⁻¹) | (cm²ml⁻¹) | particle |

Solvent:Ethanol

| | | | | | |
|---|---|---|---|---|---|
| 2.5 | 0.05 | 6 | 2.4 × 10⁶ | 4.71 × 10⁻¹ | 2.5 × 10¹⁰ |
| 2.5 | 0.01 | 6 | 0.4 × 10⁶ | 9.42 × 10⁻² | 1.25 × 10¹¹ |
| 0.5 | 0.1 | 6 | 7.3 × 10⁸ | 5.7 | 8.2 × 10⁷ |
| 0.5 | 0.3 | 6 | 2.2 × 10⁶ | 1.7 × 10 | 2.7 × 10⁷ |

Solvent:Ethanol and Water (3:1)

| | | | | | |
|---|---|---|---|---|---|
| 0.098 | 0.025 | 6 | 4.8 × 10¹⁰ | 1.45 × 10 | 1.25 × 10⁶ |
| 0.098 | 0.05 | 6 | 9.6 × 10¹⁰ | 29 | 6.2 × 10⁵ |
| 0.028 | 0.05 | 6 | 4.1 × 10¹² | 1 × 10² | 1.4 × 10⁴ |
| 0.028 | 0.1 | 6 | 8.2 × 10¹² | 2 × 10² | 7.3 × 10³ |

Table 5 shows that the total surface area of particles in those samples that produced a significant increase in the photostability were within an order of magnitude of one another for all the particle types except for the 2.5 μm Borosilicate glass. It is possible that the samples containing Borosilicate glass may have shown increased photostability at higher concentrations than were tested. Given the error on the measurements it is not unreasonable to suggest that there is a surface effect that inhibits the degradation of the dye molecules. The ratio of dye molecules to microparticles must also be accounted for in considering the possible role of surface effects. This ratio varies by many orders of magnitude for the different particle types which means that as the particle size is increased a smaller fraction of dye molecules are close to the surface of a microparticle. Studies of systems similar to those described here [11] have shown that less than 1% of dye molecules are near to the microparticle and thus the significance of surface effects is likely to be low.

A third set of experiments measured the laser performance of pyrromethene 567 doped PMMA dye lasers doped with added silica microspheres. A photostability of 107 GJ/mol was demonstrated when doped with a concentration of 0.4 mg/ml for 0.5 μm diameter silica spheres and 80 GJ/mol for 0.05 mg/ml concentration of 2.5 μm

diameter borosilicate spheres. This compares to 44 GJ/mol for non-sphere doped samples. Dye concentration was 3.34×10⁻⁴M for all samples with a pump fluence of 0.154 J/cm², Q-switched at 10 Hz with pulse width 10 ns. Both results show good correlation with theoretical calculations for oxygen quenching of diffused oxygen onto the surface of the microspheres.

Conversion efficiency of 31% and 33% was found for 0.5 μm spheres at 0.05 mg/ml and 0.5 mg/ml concentrations respectively, compared to 22% for non-sphere doped samples. Intermediate concentrations displayed a slight reduction.

A fourth set of experiments compared the photostability of organic solutions with and without microparticles. In these experiments a xenon lamp was used to photoirradiate the solutions and the photodegradation processes were tracked by periodically obtaining absorption spectra.

The xenon lamp was filtered with both an ultra-violet (for safety purposes) and an infra-red filter, which meant that any photodegradation that occurred was the result of visible radiation. It was fitted with a parabolic reflector that ensured that a roughly collimated beam of light was provided that was approximately 4 cm in diameter. The optical power of the lamp was measured to be 1.9 W. A glass slide was positioned 45° to the beam to take off 10% of the light energy and redirect it to a silicon detector to monitor the power of the lamp throughout the experiment. The remaining 90% of the beam power was directed into two 1×1×3 cm cuvettes, containing the solutions under test, placed side by side in the light beam. Each cuvette received half of the power from the lamp. One cuvette contained microparticles, whereas the other did not and therefore acted as the control sample to ascertain the effect of the microparticles. Periodically, the cuvettes were interchanged to eliminate any error that may occur because of a lack of symmetry of light beam. To track the amount of photodegradation occurred, the two cuvettes were periodically removed from the beam and placed in a spectrophotometer. The absorption spectra obtained were compared with the original spectrum obtained before any irradiation, and the change in optical density, which is proportional to the change in concentration, was obtained by subtraction.

In this experiment an electroluminescent polymer, a PPV derivative, was used with a concentration of 0.17 mg/m in toluene. To the solution one of two types of microparticles was added, 0.525 mg/ml silica microspheres of 0.5 μm diameter or 0.02 mg/ml fumed silica particles of 0.007 μm average diameter.

In toluene both types of microparticles, in the concentrations used, caused measurable levels of optical scatter. The level of optical scatter also decreased with time, an effect that was corrected for in the absorption data by measuring the optical density associated with the total scatter as a function of time and subtracting this from the absorption data of the solutions containing electroluminescent polymer. In this way changes due only to the change in electroluminescent polymer concentration could be tracked accurately. As a check, the experiment was performed with two control samples, whose comparative absorption spectra deviated by not more than 1% thus defining the accuracy of the experiment.

FIGS. 4a and 4b show differential absorption spectra of electroluminescent polymer solutions at two different irradiation times, corrected for optical scatter changes, for silica microspheres and fumed silica particles respectively. It can be seen that the change in absorbance of the solutions containing microparticles are significantly smaller than the control sample, confirming the stabilisation effect of both types of microparticles in a toluene solution of electroluminescent polymer. The insets in each figure track the change in the peak of the electroluminescent polymer absorbance in both microparticle containing solutions and control solutions as a function of energy received. According to the insets, the level of stabilisation achieved in these systems can be quantified as 38% for silica microspheres and 66% for fumed silica microparticles.

The invention has been implemented using the following microparticles: latex polymer, silica, borosilicate glass and β-alumina, Microparticles formed from any other suitable material may be used to implement the invention, for example particles made from other glasses, ceramics or polymer materials. The microparticles need not be spherical or even of regular shape.

The diameters of the particles used were in the range 0.028 μm to 2.5 μm. Since the wavelength of the pump laser was 0.532 μm, this corresponds to a particle diameter ranging from approximately 1/20^{th} of the pump laser wavelength to approximately 6 times the pump laser wavelength. The experiments did not indicate an upper boundary or lower boundary of particle diameter.

The concentrations of the particles used in the first set of experiments were estimated to be in the range 0.01 mg/ml to 9.75 mg/ml. The concentration of the particles used in the second and third sets of experiments were in the range 0.05 mg/ml to 1 mg/ml. The concentration in the PMMA is estimated to be approximately 20% higher than that in the solution due to a small amount of shrinkage on polymerisation. The concentration of microparticles at which the greatest photostabilisation was found to vary for different sizes of microparticles. It appears that at high concentrations, the optical transmission of the solution was compromised, thereby reducing the efficiency of the dye laser.

The total microparticle surface area per sample was determined for the second set of experiments for solutions which provided the best photostability. The range was found to be 1.4×10⁻⁶ to 6.6×10⁻³ cm² (this corresponds to approximately 2.8×10⁻⁶ to 1.3×10⁻² cm² per ml). Discounting solutions containing borosilicate glass (which was not used at high concentrations) the range was found to be 1.2×10⁻⁴ to 6.6×10⁻³ cm² (this corresponds to approximately 2.4×10⁻⁴ to 1.3×10⁻² m² per ml).

The invention was implemented in solutions (or solids) containing the following dyes: pyrromethene 567, rhodamine 6G and coumarin 590. It will be apparent that the invention could be implemented in solutions (or solids) containing other suitable dyes.

It will be appreciated that all of the particles used to implement the invention do not rely on some active internal property of the particles. Instead, it is the interaction of the particles with the organic material which provides the photostabilisation.

The organic material may be any suitable solid, or may be any suitable solution.

Although the described embodiments of the invention are photoluminescent or electroluminescent materials, it will be appreciated that the invention may be implemented for other organic pigmented compounds.

It is generally believed that photodegradation of organic materials is caused by photo-oxidation. It is considered likely by the inventors that oxygen molecules in an organic material containing microparticles are adsorbed by the microparticles, thereby reducing the number of oxygen molecules that are free to photo-oxidise the dye material. This hinders free oxygen diffusion and hence reduces oxygen reaction rate, both for excitation of singlet oxygen and the collisional reaction of single oxygen with dye molecules.

Other mechanisms which may give rise to enhanced photostability in the presence of microparticles include:
(a) Quenching of free oxygen in singlet states by particles. This does not require the oxygen to be adsorbed onto the particles.
(b) Quenching of dye molecules in triplet states. This reduces singlet oxygen formation by reducing energy transfer from the dye triplet state.
(b) Adsorption of dye molecules onto particles. This would require adsorption of the dye molecules in multilayers to take up enough dye.

Other mechanisms, but which are considered less likely are:
(d) Role of whispering gallery modes or evanescent waves in the particle. This is unlikely as the particles have various optical qualities and the effect has been seen with irregular shaped particles.
(e) Modification by the presence of the particles of the radiative properties of the dye. This is also unlikely as the photostabilisation effect occurs with little discernible change in the laser efficiency.

### REFERENCES

1. M. D. Rahn and T. A. King, “Comparison of laser performance of dye molecules in sol-gel, polycom, ormosil and poly(methyl methacrylate) host media”, Appl. Opt., 34(36), 8260-8271 (1995).
2. J. H. Burroughes, D. D. C. Bradley, A. R. Brown, R. N. Marks, K. Mackay, R. H. Friend, P. L. Bums, A. B. Holmes, “Light-emitting-diodes based on congugated polymers” Nature 347(6293), 539-541 (1990).
3. J. Messier, F. Kajzar and P. Prasad, Eds., “Organic Molecules for Non-Linear Optics and Photonics”, Kluwer Academic (1991).
4. B. Oregan and M. Gratzel, “A low cost, high efficiency solar cell based on dye-sensitised colloidal TiO₂ films” Nature 353(6346), 737-740 (1991).
5. A. N. Fletcher, “Laser dye stability Part 7. Effects of temperature, UV filter and solvent purity”, Appl. Phys. B 27(2), 93-97 (1982).
6. M. D. Rahn, T. A. King, A. A. Gorman and I. Hamblett “Photostability enchancement of Pyrromethene 567 and Perylene Orange in oxygen-free liquid and solid dye lasers” Appl. Opt 36(24), 5862-5871 (1997).
7. A. A. Gorman, I. Hamblett, T. A. King and M. D. Rahn, “A pulse radiolysis and pulsed laser study of pyrromethene 567 triplet states”, J Photochem and Photobiol. A, Chem 130(2-3), 127-132(2000).
8. M. Ahmed, M. D. Rahn and T. A. King “Singlet oxygen and dye-triplet-state quenching in solid-state dye lasers” consisting of pyrromethene 567-doped poly(methylmethacrylate), Appl. Opt. 38 (30), 6337-6342 (1999).
9. M. D. Rahn and T. A. King “Comparison of solid-state dye laser performance in various host media”. Solid State Lasers VIII, R. Scheps ed., Proc SPIE 3613, 94-105 (1999).
10. T. A. King, M. Ahmed, A. A. Gorman, I. Hamblett and M. D. Rahn “Dye-triplet-state and singlet oxygen quenching effects in solid state dye lasers” in Solid State Lasers IX, R. Scheps ed., Proc SPIE 3929, 145-153 (2000).
11. N. M. Lawandy, Nature 368, 436-438 (1994)

1. An Organic Light Emitting Diode which comprises a composition incorporating an electroluminescent organic material sandwiched between two electrodes wherein said composition contains a plurality of particles with a size of 1 to 20 nanometers which serve to enhance the photostability of the organic material.

2. A Diode as claimed in claim 1 where the particles do not include internally any photo-active elements.

3. A Diode according to claim 1 wherein the particles have a diameter greater than 0.005 μm.

4. A Diode according to claim 3, wherein the particles have a diameter greater than 0.01 microns.

5. A Diode according to claim 1, wherein the particles have a diameter which is not less than 1000 times smaller than the wavelength of light in which the organic material is desired to be photostable.

6. An Organic Light Emitting Diode which comprises a composition incorporating an electroluminescent organic material sandwiched between two electrodes wherein said composition contains a plurality of particles for enhancing photostability of said organic material wherein the particles have a diameter which is not less than 1000 times smaller and not more than 6 times greater than the wavelength of light in which the organic material is desired to be photostable.

7. A Diode according to claim 1, wherein the concentration of particles in the organic medium is greater than 0.01 mg/ml.

8. A Diode according to claim 7, wherein the concentration of particles in the organic medium is between approximately 0.05 and 10 mg/ml.

9. A Diode according to claim 1, wherein the total particle surface area is greater than 2.8 cm²×10⁻⁶ cm² per ml.

10. A Diode according to claim 9, wherein the total particle surface area is between 2.4×10⁻⁴ to 1.3×10⁻¹ cm² per ml.

11. A Diode according to claim 1, wherein the particles are made from ceramic, glass, polymers, latex polymer, silica, colloidal silica, sols, borosilicate glass, β-alumina, PMMA or polystyrene.

12. A Diode according to claim 1 wherein the electroluminescent material is Alq3 (8-hydroxyquinolene aluminium), PPV (poly(phenylene vinylene)), polyfluorenes, dendrimers and organolanthindes.

13. A laser comprising a composition incorporating a photoluminescent material containing a plurality of particles which serve to enhance photostability of the organic material.

14. A Laser according to claim 13, wherein the photoluminescent material is pyrromethene 567, rhodamine 6G or coumarin 590.

15. A Laser as claimed in claim 13 wherein the organic material is selected from pyrromethene 567, rhodamine 6G and coumarin 590 and the particles are selected from latex, silica and borosilicate glass.

16. A composition comprising an organic material and a plurality of particles which serve to enhance photostability of the material.

17. A composition as claimed in claim 16 where the particles do not include internally any photo-active elements.

18. A composition as claimed in claim 16 wherein the organic material is a light absorbing material.

19. A composition comprised of a light absorbing organic material and a plurality of particles which serve to enhance photostability of the material.

20. A composition according to claim 16 wherein the material is a photoluminescent material.

21. A composition according to claim 16 wherein the material is a electroluminescent material.

22. A composition according to claim 16 wherein the particles have a diameter greater than 0.001 μm.

23. A composition according to claim 22 wherein the particles have a diameter greater than 0.005 μm.

24. A composition according to claim 23, wherein the particles have a diameter greater than 0.01 microns.

25. A composition according to claim 16, wherein the particles have a diameter less than 5 microns.

26. A composition according to claim 24, wherein the particles have a diameter between 0.03 microns and 2.5 microns.

27. A composition according to claim 16, wherein the particles have a diameter which is not less than 1000 times smaller than the wavelength of light in which the organic material is desired to be photostable.

28. A composition according to claim 27, wherein the particles have a diameter which is not less than 20 times smaller than the wavelength of light in which the organic material is desired to be photostable.

29. A composition according to claim 16, wherein the particles have a diameter which is not more than 30 times greater than the wavelength of light in which the organic material is desired to be photostable.

30. A composition according to claim 29, wherein the particles have a diameter which is not more than 6 times greater than the wavelength of light in which the organic material is desired to be photostable.

31. A composition according to claim 16, wherein the concentration of particles in the organic medium is between approximately greater than 0.01.

32. A composition according to claim 31, wherein the concentration of particles in the organic medium is between approximately 0.05 and 10 mg/ml.

33. A composition according to claim 16, wherein the total particle surface area is greater than 2.8×10⁻⁶ cm² per ml.

34. A composition according to claim 33, wherein the total particle surface area is between 2.4×10⁻⁴ to 1.3×10⁻¹ cm² per ml.

35. A composition according to claim 16 wherein the particles are made from ceramic, glass, polymers, latex polymer, silica, colloidal silica, sols, borosilicate glass, β-alumina, PMMA or polystyrene.

36. A composition according to claim 20, wherein the photoluminescent material is pyrromethene 567, rhodamine 6G or coumarin 590.

37. An Organic Light Emitting Diode comprising a composition as claimed in claim 21.

38. An OLED as claimed in claim 37 wherein the particles have a size greater than 1 nanometer.
